(19) United States
(12) Patent Application Publication
(10) Pub. No.: US 2007/0154835 A1
(43) Pub. Date: Jul. 5, 2007

(54) Positive photosensitive composition

(75) Inventor: Tsutomu Sato, Chiba (JP)

Correspondence Address: MCGLEW & TUTTLE, PC, P.O. BOX 9227, SCARBOROUGH STATION, SCARBOROUGH, NY, 10510-9227, US

(73) Assignee: THINK LABORATORY CO., LTD., Kashiwa-shi, Chiba (JP)

(21) Appl. No.: 10/596,741

(22) PCT Filed: May 27, 2004
(86) PCT No.: PCT/JP04/07274

§ 371 Date: Jun. 22, 2006

(51) Int. Cl. G03C 1/00

(52) U.S. Cl. 430/270.1; 430/302

(57) ABSTRACT

There is provided a positive photosensitive composition which requires no burning, makes it possible to obtain necessary and sufficient adhesion when it is applied under a humidity of 25 to 60%, makes it possible to carry out development with keeping high sensitivity while forming no residue, ensures sharp edges, can provide a very hard resist film and is improved in scratch resistance in the handling before development. The positive photosensitive composition comprises, (A) an alkali soluble organic high molecular substance having a phenolic hydroxyl group,(B) a photo-thermal conversion material that absorbs infrared rays from an image exposure light source and converts it to heat, (C) at least one resin selected from the group consisting of; (1) vinylpyrrolidone/vinyl acetate copolymer and others, and (D) a dissolution inhibitor.

### TECHNICAL FIELD

The present invention relates to an alkali soluble positive photosensitive composition having sensitivity to a laser light of an infrared wavelength region so that when exposed to a laser light of from 700 to 1,100 nm, the exposed portion becomes soluble in an alkali developer. The positive photosensitive composition of the present invention is especially used in the field of a photofabrication in a printing plate, an electronic part, a precision machine part and so on.

### BACKGROUND ART

As a method for forming a positive image by increasing solubility of an exposed portion to a developer by change other than chemical change, there has been watched a method in which a positive photosensitive composition is printed by using a laser light of wavelengths of from 700 to 1,100 nm (for example, see patent documents 1 to 9 and so on).

The positive photosensitive composition which forms a coating film of a lithographic printing plate as described in the above patent documents comprises a material which absorbs an infrared light of infrared absorbing coloring matter and the like and converts it to heat, and an alkali soluble resin such as a novolak resin, as a main photosensitive layer component. With the heat generated by exposing the positive photosensitive composition to the infrared laser light, the composition performs a conformation change to low molecules having higher alkali solubility due to cut of a main chain or a side chain of the molecules, and partly a physical change such as a conformation change of an ablation resin, thereby solubility thereof to a developer being increased.

On the other hand, as one of plate-making methods for a gravure printing roll, the so-called etching method in which a photosensitive film is applied to and formed on the copper sulfate plated surface of a plate-making roll, images are printed images by a laser, and then there are performed development, etching, peeling resist, and chromium-plating. In conventional etching methods, a negative photosensitive film is applied to a plate-making roll and dried up at room temperature to form a negative photosensitive film, which is then printed by an argon ion laser.

In contrast, in the plate-making of a gravure printing roll, it has not been carried out to form a positive photosensitive film and print it by the laser light of wavelengths of 700 to 1,100 nm. A gravure plate-making system having a high-resolution with the positive photosensitive film and lasers which can emit the high-power laser light of wavelengths of 700 to 1,100 nm such as a semiconductor laser, a YAG laser and so on, is not put to practical use. To realize the above system has been desired from the points such as miniaturization of the equipment and environmental light in the plate-making operation, compared with the case using the argon ion laser.

If the beam diameter of argon ion laser light is the same in size as the beam diameter of laser light having a wavelength of 700 to 1,100 nm, laser resolution is higher and process time can be substantially more reduced in the case of a positive type than in the case of a negative type. Moreover, the sharpness of a pattern is better in the case of printing a positive image on a photosensitive film of a positive photosensitive composition by a laser having a wavelength falling in the infrared region than in the case of printing a negative image on a photosensitive film of a negative photosensitive composition by an argon ion laser. This is considered to be due to a difference in the sharpness of a pattern caused by a difference between a positive photosensitive composition and a negative photosensitive composition.

A high power semiconductor laser head manufactured by CreoScitex Co., Ltd. in Canada is a type emitting a laser having a wavelength falling in the infrared region, is mounted on an offset printer, where a positive photosensitive composition is irradiated with the laser light and is probably well developed, and is thus put into practical use world-wide.

As to an etching method as one of plate-making methods of a gravure printing roll, a test was made where an undiluted solution of a positive photosensitive composition combined with a novolak resin and a cyanine dye was prepared and a positive photosensitive agent prepared by diluting the undiluted solution with a solvent was applied to the copper sulfate plating surface of a gravure-plate-making roll. Then, a laser having a wavelength falling in the infrared region was applied to the applied photosensitive agent by an infrared laser exposure apparatus (manufactured by Think Laboratory Co., Ltd.) mounted with a high-power semiconductor laser head manufactured by CreoScitex Co., Ltd. to print a positive image and then the positive image was developed. As a result, the photosensitive film was entirely peeled off and therefore any satisfactory resist image was not obtained.

In contrast, for example, the negative photosensitive agent is applied to a 200 φmm plate-making roll with the spiral scan method rotating at the low speed of 25 r.p.m., the roll was allowed to stand for a while (about 5 minutes) such that dripping of the agent was prevented, a film is formed at the time when the rotation is terminated after 15 minutes lapse from the completion of the application. By developing images after exposing the formed film with the laser, the good sharpness of a pattern can be obtained without problems.

Then, it is conceived to necessarily give adhesion force by the burning wherein the film surface is heated at a high temperature. It is conceived that there is generated the state where the film is not formed due to poor adhesion of a positive type photosensitive composition to the surface of the copper plating or the copper alloy plating. It is conceived when burning is carried out after the film has been formed, the adhesion force is increased by strengthening hydrogen bonding of alkali soluble organic polymers having phenolic hydroxyl group.

Further, as to the offset printing plate a good light-sensitive film is formed without burning, but it is necessary to perform burning for forming a light-sensitive film on a gravure plate-making roll. It is conceived that in the offset printing plate a light-sensitive film is formed on a thin aluminum plate with high adhesion therebetween, and on the contrary in the gravure plate-making roll the light-sensitive film is formed on a copper sulfate plating surface which has a bad affinity to the copper sulfate plating surface, leading to very low adhesion therebetween.

However, the above positive type photosensitive composition made up of novolac resin and cyanine dye was applied to the plate-making roll and burning was carried out for 30 minutes such that the temperature of the coating surface was 60° C., and then the film was exposed and developed with inferior development. As a result of repetition of many tests, it became clear that when the total residual solvent concentration of such as MEK, IPA, PM is about 6% or more, images can not be exposed by the laser.

For this, burning was carried out for 30 minutes such that the temperature of the coating surface was 130° C. Even though such burning was carried out, such inferior development arose that the entire surface including a non-line image portion was broken away. It was conceived that the reason why such inferior development arose even if burning was carried out was caused by excessively low adhesion of the positive photosensitive composition to the copper sulfate plating surface.

Then, in the case of using the positive type photosensitive composition, in order to make the residual solvent concentration to be 6% or less, preferably 3% or less, and in order to give the necessary and sufficient adhesion force, burning is to be necessarily performed after the application of the light-sensitive film. Further, a silane coupling agent was compounded as an auxiliary agent for improving adhesion in the positive photosensitive composition to increase the adhesion of the photosensitive film, with the result that exposure and development were carried out somewhat satisfactorily. Specifically, for example, a plate-making roll of φ200 mm was rotated at a speed as low as 25 r.p.m. to apply a positive photosensitive agent. The roll was allowed to stand for 5 minutes under a natural drying condition with continuing the rotation such that dripping of the solution was prevented, to vaporize a solvent thereby drying the photosensitive agent to the extent that no dripping of the solution arose to obtain a photosensitive film. When the produced photosensitive film was set and then subjected to burning carried out at 130° C. for 30 minutes, the concentration of a residual solvent was less than 2% and an image could be printed by a laser, making it possible to develop.

However, the adhesion to the film was not said to be the best and the exposure and development were within a somewhat good range. Also, when the temperature of the film surface was 130° C., 100 minutes or more time was required for burning and the successive cooling and a large amount of heat energy was therefore necessary, leading to high running costs and it was thus found that this method was scarcely put into practice. Also, when the temperature of the film surface was 130° C., the hydrogen bond of the alkali-soluble organic high molecular substance having a phenolic hydroxyl group was strengthened, which not only made it difficult to develop but also caused a cyanine dye to be denatured, leading to reduced sensitivity.

There are rolls made of aluminum as a base material and those made of iron as a base material as a gravure-plate-making roll. Also, these rolls are different in roll diameter and the difference in roll diameter all leads to a difference in the thickness of these rolls. Therefore, even if the rolls are heated for the same time and the heat is conducted to the roll base materials, each temperature of film surface was not always heated to 130° C. but to variously different temperatures, giving rise to the dispersion of temperature because of the difference in specific heat capacity between these rolls. It was therefore considered to be important to eliminate the problem concerning the specific heat capacity by dropping the temperature.

It was considered that the burning for reducing solvent concentration to 6% or less could be achieved by selecting a composition having good solvent-separating ability even if the burning was carried out at a temperature of film surface by far lower than 130° C. When tests in which heating time was shortened step by step was made and the burning was carried out at temperatures of film surface dropped to 80° C. to 100° C. for 50 minutes, the concentration of a solvent was confirmed to be 6% or less; however, the development was inferior. There was given a conclusion that necessary and sufficient adhesion could not be obtained by the above silane coupling agent.

Then, imidazole (including imidazole silane) which was a hardening promoter was compounded as an adhesive agent in place of the silane coupling agent. However, the positive photosensitive composition containing imidazole has no particular difference from the composition containing the silane coupling agent and the burning temperature of the film surface was also the same as in the case of the silane coupling agent.

In succession, the following experiment was conducted. Specifically, various adhesives were each added to an undiluted solution of a positive photosensitive composition containing an alkali-soluble organic high molecular substance having a phenolic hydroxyl group and a photo-thermal conversion material which absorbs infrared rays from an exposure light source to convert them into heat, to form a photosensitive film on a copper sulfate plating roll at 25° C. A test image was developed. As a consequence, in the case of a photosensitive film of a positive photosensitive composition compounded of a titanium organic compound, the burning temperature could be outstandingly dropped (see Patent document 10).

In the case of a photosensitive film of the positive photosensitive composition compounded of a titanium organic compound, the film was well formed even when the burning temperature was 46° C. and the film had good sensitivity, making it easy to develop. However, in a test in which no burning treatment was performed, only an unsatisfactory film could be formed, resulting in inferior development.

Although the burning temperature could be dropped to the vicinity of 50° C., the necessity of burning had disadvantages in that it was necessary to cool after burning, it took time and energy to carry out burning and the successive cooling and the equipment line was longer by the length of the burning equipment, increasing equipment cost and running cost. In addition, burning is a cause that when developing the resist film thins down and pin holes are generated. Therefore, there is strongly desired the development of the positive type light-sensitive film which does not require burning.

The concentrations of residual solvents when the aforementioned positive photosensitive agent compounded of a titanium organic compound was applied to a copper sulfate plating plate and dried at a room temperature of 25° C. in a natural drying condition without any air-blowing for 15 minutes and for 25 hours were 11% and 9% respectively. It was found that the concentration of solvents was dropped only to 7% from the result of measurement 10 minutes after the positive photosensitive agent was applied to the plate-making roll rotated at 45 r.p.m. Under such circumstances, even though an undiluted solutions of the positive photosensitive agent is remade by adding the adhesion auxiliary agents and it is tried to confirm the result by development, the residual solvent concentration can not be greatly lowered to 6% or less, so it was impossible that the image exposure on the positive type light-sensitive film which requires no burning.

In this situation, the inventor adopted a developing theme concerning practical use of a positive photosensitive film necessitating no burning wherein the development of a positive photosensitive film in which the adhesion of the positive photosensitive film itself could be largely improved by adding an auxiliary strengthening adhesion without burning was discriminated conceptually from the development of film-drying techniques that could greatly decrease the concentration of residual solvents to 6% or less in a short time with ease without burning, to continue the studies to simultaneously solve the two themes.

The coating film touched air and was dried from the surface thereof, increasing in hardness and, it was therefore considered that the diffusibility thereof would be more reduced as time passed and the surface was more dried. On the other hand, it was thought that after dripping of a liquid from the coating film was not seen, the pressure of the film surface was compulsorily set to the negative pressure to diffuse the residual solvents in the air, by which the residual solvents could be reduced efficiently. Here, the inventor made the plate-making roll rotate at a high speed after dripping of a liquid from the coating film was not seen, to find out the fact that the concentration of the residual solvents was dropped to 3% or less in a short time.

Based on this finding, as technologies that made it possible to decrease the concentration of solvents to 6% or less in a very short time even if the burning was not carried out, techniques were established in which the plate-making roll was rotated at a predetermined low speed with the both ends being supported horizontally in a coating apparatus of a spiral scan system, a pipe springing out the photosensitive agent from the top end thereof was placed to one end of the plate-making roll with a small gap such that the photosensitive agent could be sprung out in a necessary amount, with the pipe being moved from the one end to the other end the test photosensitive agent was applied uniformly to the plate-making roll in a spiral scan system such that the slits between the applied agent are not present and overlapped portions thereof are in the least possible space, then the rotation was continued to vaporize a solvent thereby drying the solvents to the extent that no dripping of a liquid arose to obtain a photosensitive film, which was then set to the coater, after that the plate-making roll was still set in the coating apparatus or moved to a laser exposure apparatus, and the plate-making roll was rotated at a predetermined high speed for a predetermined time to effect centrifugal force on residual solvents in the film, thereby causing friction between the film surface and air, allowing the residual solvents in the film to be diffused and separated in the air, whereby a coating film was obtained which had a low concentration of residual solvents which concentration made it possible to develop image printing ability by a laser.

A test roll of φ200 mm was coated uniformly with a sensitizing solution and rotated continuously at 25 r.p.m. for 5 minutes after the coating was finished. Then, the rotation was stopped to observe dripping of a liquid after of elapse of 5 minutes after the rotation was stopped. It was confirmed that the dripping of a liquid was not observed by naked eyes. Thereafter the test roll was rotated at 100 r.p.m. for 20 minutes and then stopped, to measure the concentration of residual solvents in the photosensitive film, to find that the concentration was 2.3%.

The technologies that could reduce the concentration of solvents 6% or less in a very short time without burning were developed. Then, studies were conducted to improve a positive photosensitive agent which has necessary and sufficient adhesion without burning after various auxiliaries strengthening adhesion are added.

As a consequence, when a cellulose derivative and at least one titanium organic compound selected from titanium alkoxide, titanium acylate and titanium chelate were added to an undiluted solution of a positive photosensitive composition containing an alkali-soluble organic high molecular substance having a phenolic hydroxyl group and a photo-thermal conversion material which absorbs infrared rays from an image exposure light source to convert them into heat, to make a test. As a result, if burning treatment was carried out, development was inferior whereas if burning treatment was not carried out, development was satisfactory and the best resist pattern was obtained.
Patent document 1: JP-A No.10-268512
Patent document 2: JP-A No.11-194504
Patent document 3: JP-A No.11-223936
Patent document 4: JP-A No.11-84657
Patent document 5: JP-A No.11-174681
Patent document 6: JP-A No.11-231515
Patent document 7: WO 97/39894
Patent document 8: WO 98/42507
Patent document 9: JP-A No.2002-189294
Patent document 10: JP-A No.2004-133025
Patent document 11: JP-B No.47-25470
Patent document 12: JP-A No.48-85679
Patent document 13: JP-B No.51-21572

### DISCLOSURE OF THE INVENTION

Problems to be Solved by the Invention

However, the test was made on a day under the condition that the humidity was accidentally very low, with the result that the photosensitive film was wholly fallen down when development was carried out. The positive photosensitive agent was known to have such humidity dependency that the blushing usually occurred under humidity as high as 60% or higher and no film could be therefore formed. However, it was clarified from the above results that the positive photosensitive agent has another humidity dependency that when the humidity was as very low as about 25%, the adhesion of the positive photosensitive agent was not also developed.

Consecutively, a variety of auxiliary agents for improving adhesion were added to the positive photosensitive agent and tested. There were added thereto, as auxiliary agents for improving adhesion, vinylpyrrolidone/vinyl acetate copolymer, vinylpyrrolidone/dimethylaminoethyl methacrylate copolymer, vinylpyrrolidone/vinyl caprolactam/dimethylaminoethyl methacrylate copolymer, polyvinyl butyral, polyvinyl formal, styrene/maleic resin, terpene phenol resin, alkylphenol resin, melamine/formaldehyde resin, polyvinyl acetate, or ketone resin. In each of the above cases, in the conditions that the temperature in a laboratory was 25° C., the humidity was changed to 25%, 30%, 55%, 60%, and a plate-making roll of φ200 mm was rotated at a speed of 25 r.p.m. , the positive photosensitive agent was applied. The roll was allowed to stand for 5 minutes under natural drying conditions with continuing the rotation such that dripping of a liquid was prevented, then rotated at 100 r.p.m. for 10 and then stopped. In this way, there were obtained four test rolls on which the very hard light-sensitive films having glossy and very strong adhesiveness to the copper sulfate plating surface of the plate-making roll. The film thickness was 3.5˜3.81 μm. The concentration of residual solvents was measured, to find that each concentration of all test rolls was around 2.3%. Then, a test image was exposed to light from a laser in the infrared wavelength region and then developed by an alkali, with the result that the film was not decreased substantially as compared with the film thickness not developed. However, in any case, an extremely sharp resist pattern free from any residue was obtained. Then, it was confirmed that a resist pattern obtained which was naturally dried was very hard. Thus, the present invention was completed.

The present invention relates to a positive photosensitive composition which is sensitized when it is exposed to laser light having a wavelength of 700 to 1,100 nm, the sensitized portion being made soluble in an alkali developing solution. It is an object of the present invention to provide a positive photosensitive composition having the following characteristics: when the composition is applied in an application working room in which the humidity is in a range from 25 to 60%, it is applied to a subject to be coated, the subsequent burning is not required, and necessary and sufficient adhesion to aluminum, of course and also to copper or copper sulfate plating which requires very stronger adhesion than aluminum is obtained; good alkali development free from the generation of residues can be accomplished in a proper time of about 60 to 70 seconds; no burning treatment is carried out and high sensitivity is therefore maintained, and the edge of a resist image has an outline cut sharply in accordance with the exposure irradiated pattern, making it possible to attain very good development; a reduction in film thickness after development is small and the generation of pinholes caused by the film reduction is reduced, ensuring very good development; a resist image is glossy, it is possible to attain a resist image having printing durability ensuring that several thousand sheets can be copied if it is subjected to printing as it is and the scratching resistance of the photosensitive film is improved in the handling before development after the photosensitive film is formed; and image printing by a laser and a latitude of development are superior.

In the present specification, the term “have latitude of development” means such a condition that plate-making can be made stably under the situation that the film thickness is not changed in the development (loss of the film thickness is little), the area of the dots is not changed for a prescribed developing time and a phenomenon that a residue (what is left) suddenly appears does not occur.

Means to Solve the Problem;

In order to solve the above problem, a positive type photosensitive composition of the present invention comprises: (A) alkali soluble organic high molecular substance having a phenolic hydroxyl group, (B) a photo-thermal conversion material that absorbs the infrared rays from an image exposure light source and converts it to heat, (C) at least one resin selected from the group consisting of;
(1)vinylpyrrolidon/vinyl acetate copolymer,
(2)vinylpyrrolidon/dimethylaminoethyl methacrylate copolymer,
(3)vvinylpyrrolidon/vinyl caprolactam/dimethylaminoethyl methacrylate copolymer,
(4)polyvinyl acetate,
(5)polyvinyl butyral,
(6)polyvinyl formal,
(7)stylene/maleic group copolymer,
(8)terpene phenol resin,
(9)alkylphenol resin,
(10)melamine/formaldehyde resin, and
(11)ketone resin, and
(D)the dissolution inhibitor.

It is preferable that the dissolution inhibitor (D) is the compound represented by the following chemical formula (1).

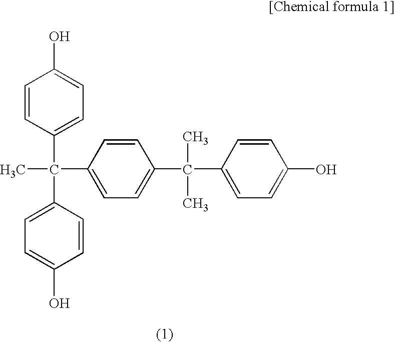

It is preferable that the photo-thermal conversion substance (B) is the compound represented by the following general formula (2).

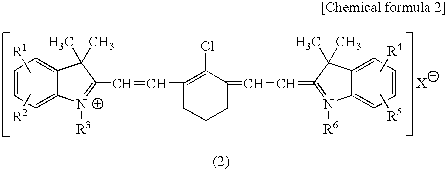

[In the formula (2), each of “R¹” to “R⁶” independently represents a hydrogen atom, a carbon number 1˜3 alkyl group, or a carbon number 1˜3 alkoxyl group, “X” represents a halogen atom, ClO₄, BF₄, TsO(p-CH₃C₆H₄SO₃), or PF₆.]

It is preferred that the photo-thermal conversion substance (B) is the compound represented by the following general formula (3).

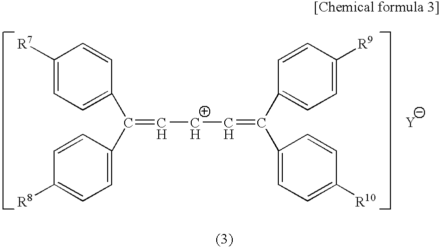

[In the formula (3), each of “R⁷”˜“R¹⁰” independently represents a hydrogen atom, methoxy group, N(CH₃)₂, or N(C₂H₅)₂, “Y” represents C₄H₉—B(C₆H₅)₃, p-CH₃C₆H₄SO₃, or CF₃SO₃.]

A photo-fabrication method of the present invention comprises the use of the positive photosensitive composition of the present invention. The photo-fabrication method is preferably applied to production of a printing plate, an electronic component, a precision equipment component and others.

A plate-making method of the present invention comprises the use of the positive photosensitive composition of the present invention. Printing plates such as an intaglio (gravure), lithography, relief and mimeograph may be produced by the plate-making method of the present invention.

A general plate-making process of a gravure plate using the positive photosensitive composition of the present invention as a sensitizing solution is as follows.
1. Application of a sensitizing solution to a cylinder (dry film thickness: preferably 2 to 5 μm, the film is preferably thicker to reduce pinholes, but the film is preferably thinner because the amount of the solution to be used is reduced and the production cost is reduced that much)→2. Drying (until touch dry: 15 minutes→until end: 15 to 20 minutes)→3. Exposure (light source: semiconductor laser 830 nm, 220 mJ/cm²)→4. Development (60 to 90 seconds/25° C.)→5. Washing with water (spray, 30 seconds)→6. Etching (depth: 10 to 30 μm, etching: a solution of cupric chloride in water, conversion of copper: 60 g/L)→7. Peeling of resist (peeling using an alkali)→8. Washing with water→9. Cr plating (chromic acid: 250 g/L, sulfuric acid: 2.5 g/L in water)→10. Washing with water→11. Printing.

A general plate-making process of a lithography (PS plate) using the positive photosensitive composition of the present invention as a sensitizing solution is as follows.
1. CTP (PS plate) (aluminum abrasion→application of a sensitizing solution →drying)→2. Exposure (light source: semiconductor laser 830 nm, 220 mJ/cm²)→3. Development→4. Printing.
   Effect of the Invention

The positive photosensitive composition of the present invention is alkali-soluble positive photosensitive composition that is sensitized when exposed to laser light in the infrared wavelength region wherein the exposed portion becomes soluble in a developing solution. The composition has the following excellent effects.
(1) Necessary and sufficient adhesion to aluminum and copper as well as even to a less adhesive subject to be coated such as glossy and mirror-like plated copper can be obtained without burning. Also, even though burning is not carried out, a photosensitive film having the same glossiness as in the conventional case of carrying out burning can be obtained.
(2) Necessary and insufficient adhesion is obtained in the condition of humidity of 25 to 60%.
(3) Good alkali development is accomplished without any generation of residues in a proper time. Although the photosensitive layer components are not substantially changed chemically by exposure to light, all of the basic performances of a printing plate such as printing durability, sensitivity and latitude of development can be satisfied.
(4) Even if image exposure is carried out using an exposure energy lower than high exposure energy causing the generation of excess heat due to a photo-thermal conversion material in the photosensitive layer, a wide latitude of development can be adopted. Therefore, because the generation of scattering of the photosensitive layer is limited to a low level, the problem that the photosensitive layer is scattered (made abrasion) to contaminate the optical system of an exposure apparatus does not arise.
(5) No burning treatment is carried out, which ensures that high sensitivity is maintained and makes it possible to attain such good development that the edge of a resist image has an outline cut sharply in accordance with the exposure irradiated pattern. Also, with regard to the end surface part, a uniform film thickness after development can be maintained as there is no dispersion of heat capacity caused by burning.
(6) A resist image is decreased in a reduction in film thickness and is glossy; pinholes are not produced even if the layer is just etched and gravure-plate-making can be accomplished. Also, a resist image is obtained which has printing durability ensuring that several thousand sheets can be copied if it is subjected to, for example, printing, and the generation of pinholes in the handling before development after the photosensitive film is dried can be avoided or scratching resistance is improved.
(7) A variation in image printing by a laser is reduced and latitude of development is superior.
(8) A reduction in film thickness after development is small and therefore the generation of pinholes is decreased.

### BRIEF DESCRIPTION OF THE DRAWINGS

FIG. 1 is a view showing a sensitizing solution test pattern used in Example 1 and measuring positions, where (a) is a test pattern and (b) is an enlarged view of the part marked by a circle in (a).

### BEST MODE FOR CARRYING OUT THE INVENTION

Embodiments according to the present invention will be explained hereinafter. However, these embodiments are shown as examples and it is needless to say that various modifications may be possible within the technical spirit of the present invention.

The positive type photosensitive composition of the present invention comprises the following components of (A)˜(D):
(A) an alkali soluble organic high molecular substance having a phenolic hydroxyl group,
(B) a photo-thermal conversion material that absorbs infrared rays from an image exposure light and converts it to heat,
(C) at least one resin selected from the group consisting of;
(1) vinylpyrrolidon/vinyl acetate copolymer,
(2) vinylpyrrolidon/dimethylaminoethyl methacrylate copolymer,
(3) vinylpyrrolidon/vinyl caprolactam/dimethylaminoethyl methacrylate copolymer,
(4) polyvinyl acetate,
(5) polyvinyl butyral,
(6) polyvinyl formal,
(7) styrene/maleic acid copolymer,
(8) terpene phenol resin,
(9) alkyl phenol resin,
(10) melamine/formaldehyde resin, and
(11) ketone resin, and
   (D) a dissolution inhibitor.

As the alkali soluble organic high molecular substance (A) having a phenolic hydroxyl group, there are listed, for example, novolac resin, resole resin, polyvinyl phenol resin, a copolymer of an acrylic acid derivative having a phenolic hydroxyl group, epoxy resin having a phenolic hydroxyl group (for example, epoxy/phenolic resin and so on), and preferably novolac resin, resol resin, or polyvinyl phenolic resin disclosed in the patent document 6 and others. These alkali soluble organic high molecular substance (A) may be used either singly or in combinations of two or more.

The novolac resin is prepared such that at least one kind of phenols is polycondensed with at least one kind of aldehydes or ketones under the presence of an acidic catalyst. The resol resin is prepared such that the same polycondensation procedure is conducted as in the preparation of the novolac resin except for the use of an alkaline catalyst instead of the acidic catalyst in the polycondensation procedure of the novolac resin. As the novolac resin and the resol resin, there are preferably used resins polycondensed with phenol, o-cresol, m-cresol, p-cresol, 2,5-xylenol, 3,5-xylenol, resorcinol, or mixed phenols of these and formaldehyde, acetaldehyde, or propionaldehyde. The novolac resin and the resol resin have preferably 1,500 to 150,000 of the weight-average molecular weight (MW) in the equivalent in polystyrene by a gel-permeation chromatography measurement.

As the polyvinyl phenolic resin, there are mentioned, for example, resins prepared in such a way that one or two or more of hydroxyl styrenes is polymerized under the presence of a radical polymerization initiator or a cationic polymerization initiator. As the hydroxyl styrenes, there are preferably used polymers of hydroxyl styrenes having 1˜4 carbon number alkyl groups as substituent groups on benzene rings and polymers of hydroxyl styrenes having no substituent groups on benzene rings. In addition, as the polyvinyl phenolic resin, there may be employed polyvinyl phenol derivatives (for example, t-butylated or styrenated polyvinyl phenol derivatives), and copolymers of vinyl phenol and the other vinyl monomers (for example, vinyl phenol/methyl methacrylate copolymer, vinyl phenol/styrene copolymer, vinyl phenol/2-hydroxylethyl methacrylate copolymer, and vinyl phenol/phenyl maleic imide copolymer).

There is no particular limitation to the content of the alkali soluble organic high molecular substance (A) in the positive type photosensitive composition of the present invention. However, the content is preferably 80 to 95% and more preferably 90 to 94% by weight based on the total solid amount of components (A), (B), (C) and (D).

As the above photo-thermal conversion material (B), any material may be used insofar as it is a compound capable of converting absorbed light into heat. Examples of the photo-thermal conversion material (B) include organic or inorganic pigments and dyes, organic coloring matter, metals, metal oxides, metal carbonates and metal borates, which have an absorption band in a part or all of the infrared region of wavelength of 700 to 1,100 nm. A preferable example of the photo-thermal conversion material (B) is a light-absorbing dye that efficiently absorbs light having the above wavelength range and does not almost absorb light in the ultraviolet region or does not substantially sensitized by the light if it absorbs the light. A Compound represented by the following formula (2) or (3) and their derivatives are preferably used.

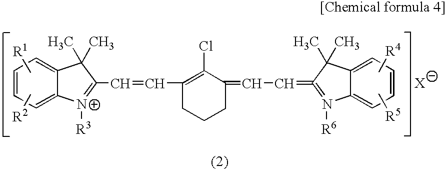

In the formula (2), each of “R¹” to “R⁶” independently represents a hydrogen atom, an alkyl group having 1 to 3 carbon atoms or an alkoxyl group having 1 to 3 carbon atoms. “X⁻” represents a counter anion and examples of “X” include a halogen atom, ClO₄, BF₄, p-CH₃C₆H₄SO₃ or PF₆.

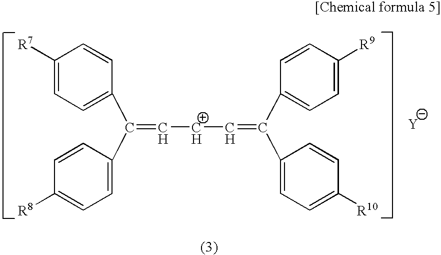

In the formula (3), each of “R⁷” to “R¹⁰” independently represents a hydrogen atom, a methoxyl group, —N(CH₃)₂ or —N(C₂H₅)₂ and “Y⁻” represents a counter anion. Examples of “Y” include C₄H₉—B(C₆H₅)₃, p-CH₃C₆H₄SO₃ or CF₃SO₃.

As the compound represented by the formula (3), near-infrared ray absorbing dyes are preferable which have the maximum absorption wavelength in the near-infrared region and are represented by the following formulae (4) to (7).

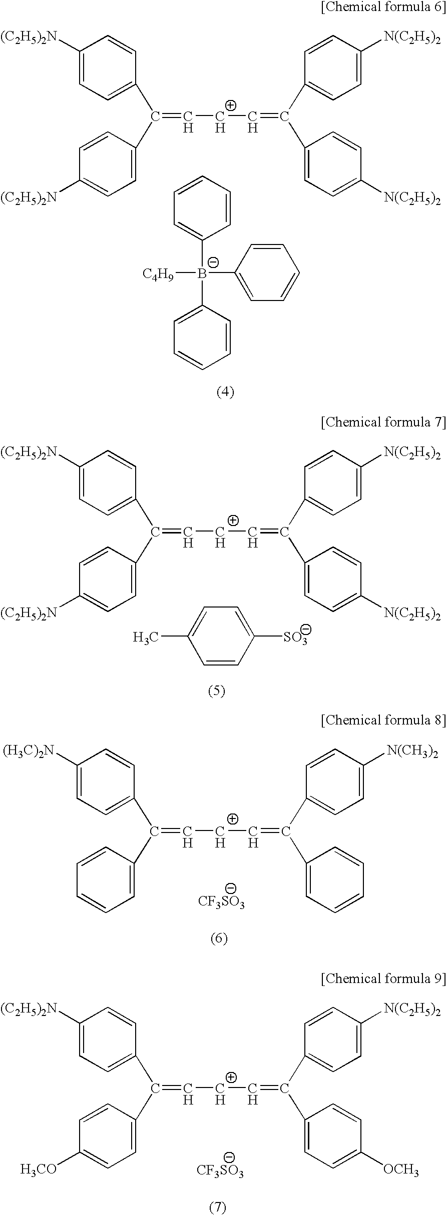

Also, examples of other light-absorbing dyes include cyanine dyes so-called in a wide sense which have the structure in which a heterocyclic ring containing a nitrogen atom, an oxygen atom or a sulfur atom are combined by a polymethine (—CH═)n as described in Patent document 6. Specific examples of these cyanine dyes include a quinoline type (so-called cyanine type), indole type (so-called indocyanine type), benzothiazole type (so-called thiocyanine type), iminocyclohexadiene type (so-called poly-methine type), pyrylium type, thiapyrylium type, squarylium type, croconium type and azulenium type. Among these types, a quinoline type, indole type, benzothiazole type, iminocyclohexadiene type, pyrylium type or thiapyrylium type is preferable. Specifically, phthalocyanine or cyanine is preferable.

The aforementioned photo-thermal conversion material (B) has an absorption band in a part or all of the infrared region of a wavelength of 700 to 1,100 nm, has the characteristics that it absorbs laser light of the infrared wavelength region to be heat-decomposed, and participates in molecular reduction/abrasion relative to alkali solubility which is caused by thermal cutting of a molecule of the high molecular substance (A) having a carboxyl group.

The quantity of the photo-thermal conversion material to be added relates to whether heat generated in exposure is excessive or insufficient and also, the intensity of the infrared laser relates to whether the heat decomposition of organic high molecular substance existing in the exposed portion is excessive or insufficient. Therefore, the amount of the photo-thermal conversion material is designed to be an appropriate amount. The content of the photo-thermal conversion material (B) in the positive photo-sensitive composition of the present invention is preferably 0.1 to 10% by weight and more preferably 1 to 4% by weight based on the total solid amount of the components (A), (B), (C), (D), (E) and (F).

The resin (C) is at least one alkali soluble resin selected from the group consisting of the following resins and functions as an adhesion improving agent:
(1)vinyl pyrrolidon/vinyl acetate copolymer,
(2)vinyl pyrrolidon/dimethylaminoethyl methacrylate copolymer,
(3)vinyl pyrrolidon/vinyl caprolactam/dimethylaminoethyl methacrylate copolymer,
(4)polyvinyl acetate,
(5)polyvinyl butyral,
(6)polyvinyl formal,
(7)styrene/maleic acid copolymer,
(8)terpene phenol resin,
(9)alkyl phenol resin,
(10)melamine/formaldehyde resin, and
(11)ketone resin.

The (1) vinyl pyrrolidon/vinyl acetate copolymer (hereinafter referred to as PVP/VA copolymer) includes the thermoplastic resins obtained by copolymerization of vinyl pyrrolidon and vinyl acetate, and has the structure represented in the following general formula (8).

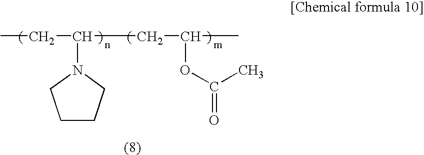

In the formula (8), each of n and m is an integer of 1 or more. The proportion of vinyl pyrrolidon and vinyl acetate in the PVP/VA copolymer is not specifically limited, but is preferably in the range of from 70/30 to 30/70, and more preferably 50/50.

The method for preparing the PVA/VA copolymer is not specifically limited, but there is preferable the linear random copolymer obtained by free radical polymerization of vinyl pyrrolidon and vinyl acetate. The molecular weight of the PVP/VA copolymer is also not specifically limited, but is preferably 10,000˜60,000, and more preferably 20,000˜50,000.

The (2) vinyl pyrrolidon/dimethylaminoethyl methacrylate copolymer has the structure represented in the following general formula (9).

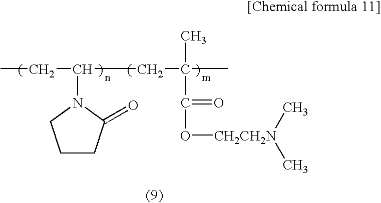

In the formula (9), each of n and m is an integer of 1 or more.

The (3) vinyl pyrrolidon/vinyl caprolactam/dimethylaminoethyl methacrylate copolymer is the copolymer of vinyl pyrrolidon, vinyl caprolactam, and dimethylaminoethyl methacrylate, and has the structure represented in the following general formula (10).

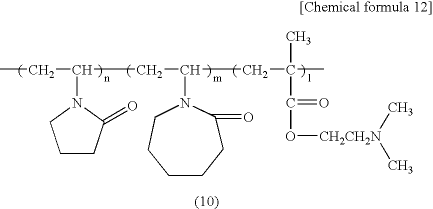

In the formula (10), each of n, m, and 1 is an integer of 1 or more.

The (4) polyvinyl acetate includes the polymers of vinyl acetate alone or the copolymer in which vinyl acetate is present as a major component, and has the structure represented in the following general formula (11).

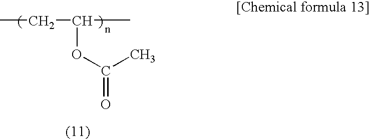

In the formula (11), n is a integer of 1 or more. As the polyvinyl acetate, there is preferably used Sacnol SN-09T (a trade name) of DENKI KAGAKU KOGYO KABUSHIKI KAISHA, for example.

The (5) polyvinyl butyral (PVB for short) is the resin obtained by butyralization in which polyvinyl alcohol and butylaldehyde are reacted, and has the structure represented in the following general formula (12).

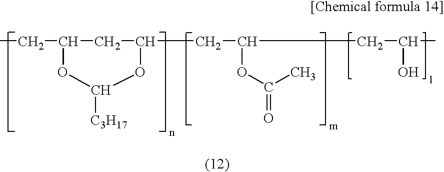

In the formula (12), each of n, m, and 1 is an integer of 1 or more. As polyvinyl butyral, there are preferably listed, Denka Butyral 5000A and 6000EP of the products of DENKI KAGAKU KOGYO KABUSHIKI KAISHA, the low polymerization degree type BL-1, BL-2, BL-S and BX-L, the medium polymerization degree type BM-1, BM-2, BM-5 and BM-S, the high polymerization degree type BH-3, BH-S, BX-1, BX-2. BX-5, BX-55 of the products of SEKISUI CHEMICAL CO.,LTD. and others, especially, and it is especially preferable to use BL-S, BM-S and BH-S having solubility in a wide variety of solvents.

The (6) polyvinyl formal (PVFM) includes the resins having good electric non-conductance, and has the structure represented in the following general formula (13).

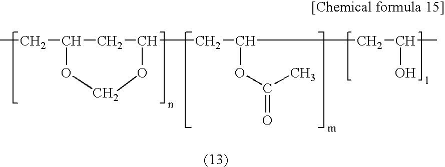

In the formula (13), each of n, m, and 1 is a integer of 1 or more. The method for preparing the polyvinyl formal is not specifically limited, but the following process may be used, for example: polyvinyl acetate is dissolved in acetic acid, a saponification reaction and a formalation reaction are performed at the same time by adding formaldehyde and sulfuric acid, polyvinyl formal is precipitated by adding dilute sulfuric acid to the reaction liquid, and a polyvinyl formal product is obtained by way of the processes of solvent recovery, washing, and drying.

The (7) styrene/maleic acid copolymer includes the copolymers obtained by copolymerization of stylene monomers and maleic acid monomers, a derivative of the copolymer or a modified substance thereof. The (7) styrene/maleic acid copolymer may preferably contain the carboxyl group so that the acid number is in 30˜200 and especially 50˜170. The weight average molecular weight thereof is preferably 1,500˜100,000.

The styrene monomer includes styrene or a derivative thereof, and there may be listed, for example, styrene, α-methylstyrene, m- or p-methoxystyrene, p-methylstyrene, p-hydroxystyrene, 3-hydroxymethyl-4-hydroxystyrene and the like.

The maleic acid monomer includes maleic acid or an derivative thereof, and there may be listed, for example, maleic anhydride, maleic acid, or maleic acid esters such as monomethyl maleate, monoethyl maleate, mono-n-propyl maleate, monoisopropyl maleate, mono-n-butyl maleate, monoisobutyl maleate and mono-tert-butyl maleate.

The (7) styrene/maleic acid copolymer is preferably the copolymer [hereinafter referred to as copolymer (a)] of the styrene monomer and the maleic acid monomer having the following general formula (14). In addition, as the (7) styrene/maleic acid copolymer, it is possible to use such a copolymer as copolymerized further with other monomers including, for example, vinyl monomers such as acrylic monomers (for example, alkyl methacrylates such as methyl methacrylate and t-butyl methacrylate, and alkyl acrylates).

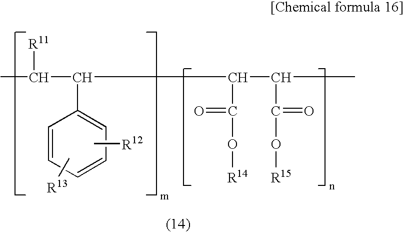

In the formula (14), R¹¹ represents a hydrogen atom or a methyl group, R¹² represents a hydrogen atom, a hydroxyl group, an alkyl group or an alkoxyl group, R¹³ represents an hydrogen atom or hydroxyalkyl group, each of R¹⁴and R¹⁵ independently represents a hydrogen atom, a lower alkyl group or a group having a reactive double bond, each of m and n is an integer of 1 or more, and a relation of m≧n is preferable.

Also, as the (7) styrene/maleic acid copolymer, it may be possible to use a substance [hereinafter referred to as copolymer (b)] obtained by modifying the copolymer (a) with a compound having a reactive double bond. In the formula (14) of this case, each of m and n is an integer of 1 or more, a relation of m≧n is preferable, and a relation of m/n=1˜1.1 is more preferable. The above copolymer (b) can be specifically prepared such that a compound having a reactive double bond is reacted with an acid anhydride group or a carboxyl group in the copolymer (a). In this case, for the purpose of improving adhesion thereof, it is preferable that the carboxyl group remains in the copolymer.

The compound having a reactive double bond may preferably be a compound having a carbon-carbon double bond, and specifically may include such as unsaturated alcohols (for example, allyl alcohol, 2-buten-1-2-ol, furfuryl alcohol, oleyl alcohol, cinnamyl alcohol, 2-hydroxyethyl acrylate, hydroxyethyl methacrylate, and N-methylol acrylamide), alkyl (meth) acrylate (for example, methyl methacrylate, and t-butyl methacrylate), and epoxy compounds having one oxirane ring and one reactive double bond (for example, glycidyl acrylate, glycidyl methacrylate, allyl glycidyl ether, α-ethylglycidyl acrylate, crotonyl glycidyl ether, itaconic acid monoalkyl monoglycidyl ester).

As the above copolymer (b), it may be possible to use a copolymer with a higher concentration of the reactive double bond obtained by reacting the epoxy compounds having one oxirane ring and one reactive double bond with the substance in which a reactive double bond was introduced by unsaturated alcohols to further raise the concentration of the reactive double bond.

A method for preparing the above copolymers (a) and (b) is not specifically limited, and it is possible to prepare them according to the known methods (for example, see Patent documents 11˜13.). It is preferable to give reactive double bonds to the copolymer in terms of curing extent and plate wear.

As the terpene phenol resin (8), the known ones can be widely used. Specifically, there are preferably listed Tamanoru 803L and 901 (trade names of productions by Arakawa Chemical Industries, LTD).

As the alkyl phenol resin (8), the known ones can be widely used. Specifically, there are preferably listed Tamanoru 520S, 521, 526, 586 and 572S (trade names of productions by Arakawa Chemical Industries, LTD).

The (10) melamine-formaldehyde resin is a resin obtained with the addition condensation reaction of melamine and formaldehyde, and the known melamine-formaldehyde resins can be used widely. Specifically, for example, it is preferable to use Banceline SM-960 (a trade name) by HARIMA CHMICALS, INC.

As the (11) ketone resin, the known ketone resins can be used without specific limitation. For example, the ketone resins can be obtained by the reaction of ketones and formaldehyde with the known method. As ketones, there are listed, for example, methyl ethyl ketone, methyl isobutyl ketone, acetophenone, cyclohexanone, and methyl cyclohexanone, and especially cyclohexanone and acetophenone are preferable. As the ketone resin, cyclohexanone series ketone resins represented in the following formula (15) and acetophenone series ketone resins represented in the following formula (16) are preferable.

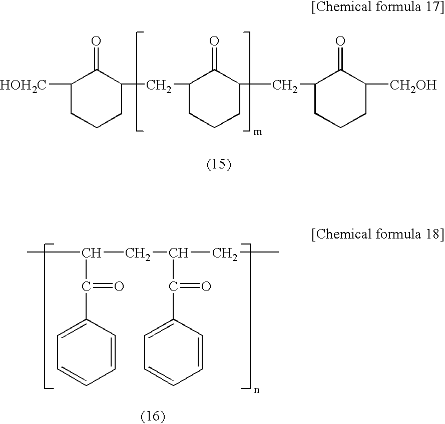

In the formula (15) and the formula (16), each of m and n is an integer of 1 or more.

The content of the resin (C) in the positive type photosensitive composition of the present invention is preferably in the range of 1˜40% by weight based on the total solid content of the components(A), (B), (C) and (D), and more preferably 5˜30% by weight.

The aforementioned dissolution inhibitor (D) is compounded for the purpose of increasing a time difference of solubility in an alkali developing solution between an exposed portion and an unexposed portion. As the dissolution inhibitor (D), a compound is used which has the ability of forming a hydrogen bond together with the alkali soluble organic high molecular substance to reduce the solubility of the high molecular substance, does not almost absorb light in the infrared region and is not decomposed by light in the infrared region.

As the dissolution inhibitor (D), it is preferable to use the compound (4,4′-[1-[4-[1-(4-hydroxyphenyl)-1-methyl ethyl] phenyl] ethylidene] bis-phenol) represented by the following formula (1).

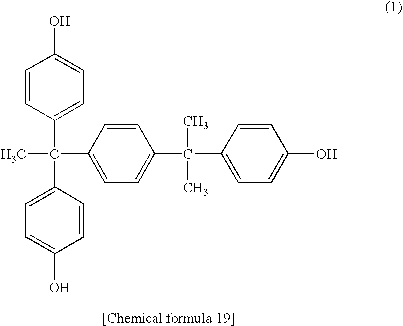

Also, known dissolution inhibitors may be used as the dissolution inhibitor (D). Specific examples of the dissolution inhibitor (D) include a sulfonic ester, phosphoric ester, aromatic carboxylic ester, aromatic disulfone, carboxyanhydride, aromatic ketone, aromatic aldehyde, aromatic amine, aromatic ether, acid color developing dyes having a lactone skeleton, thio-lactone skeleton, N,N-diaryl amide skeleton or diaryl methylimino skeleton, base color developing dyes having lactone skeleton, thiolactone skeleton or sulfolactone skeleton, nonionic surfactant and so on. Among these materials, acid color developing dye having lactone skeleton is preferable.

The content of the dissolution inhibitor (D) in the positive photo-sensitive composition of the present invention is preferably 0.5 to 8% by weight and more preferably 1 to 5% by weight based on the total solid amount of the components (A), (B), (C), (D), (E) and (F). These dissolution inhibitors may be used either singly or in combinations of two or more.

The positive photosensitive composition of the present invention may comprise, besides the aforementioned components, if necessary, various additives such as coloring agents such as other pigments or dyes, a photo sensitizer, a developing promoter and a coating improving agent. As the photo sensitizer, there is preferably employed a compound (a photo-acid generator) which generates acid by light. As the developing promoter, for example, dicarboxylic acid, amines or glycols is preferably added in a small amount.

The positive photosensitive composition of the present invention is usually used in the form of a solution obtained by dissolving the composition in a solvent. The proportion by weight of the solvent to be used is generally in the range of from 1 to 20 times the total solid content of the photosensitive composition.

As the solvent, any solvent may be used without any particular limitation insofar as it has enough solubility to components used and imparts good coatability, and a cellosolve type solvent, propylene glycol type solvent, ester type solvent, alcohol type solvent, ketone type solvent or highly polar solvent may be used. Examples of the cellosolve type solvent include methyl cellosolve, ethyl cellosolve, methyl cellosolve acetate and ethyl cellosolve acetate. Examples of the propylene glycol type solvent include propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate, dipropylene glycol dimethyl ether. Examples of the ester type solvent include butyl acetate, amyl acetate, ethyl butyrate, butyl butyrate, diethyl oxalate, ethyl pyruvate, ethyl-2-hydroxybutyrate, ethyl acetoacetate, methyl lactate, ethyl lactate and methyl-3-methoxy-propionate. Examples of the alcohol type solvent include heptanol, hexanol, diacetone alcohol and furfuryl alcohol. Examples of the highly polar solvent include ketone type solvents such as cyclohexanone and methyl amyl ketone, dimethylformamide, dimethylacetamide and N-methyl-pyrrolidone. Examples other than the above include acetic acid, mixtures of these solvents, and, further, solvents obtained by adding an aromatic hydrocarbon to these solvents.

The positive photosensitive composition of the present invention may be produced in the following manner. Usually, the above each component is dissolved in a solvent such as a cellosolve type solvent or propylene glycol type solvent to make a solution, which is then applied to the surface of the support, specifically, the copper or copper sulfate plating surface of the plate-making roll for gravure printing use and naturally dried. Then, the roll is rotated at high speed so that the surface of the plate-making roll go through the air. A mass effect due to centrifugal force in the photosensitive film and the condition of the neighborhood of the surface placed under a slightly negative pressure allow the concentration of residual solvents to be reduced to 6% or less, to thereby make a positive photosensitive film with the photo-sensitive composition layer being formed on the surface of the support.

As a coating method, meniscus coating, fountain coating, dip coating, rotary coating, roll coating, wire bar coating, air-knife coating, blade coating and curtain coating may be used. The thickness of the coating film is in a range preferably from 1 to 6 μm and more preferably 3 to 5 μm.

As the light source used for image exposure of the positive photo-sensitive composition layer, a semiconductor laser and a YAG laser which emit infrared laser rays having a wavelength of 700 to 1,100 nm are preferable. Besides the above, a solid laser such as a ruby laser and LED may be used. The intensity of the laser light source is designed to be 2.0×10⁶ mJ/s·cm² or more and particularly preferably 1.0×10⁷ mJ/s·cm² or more.

As a developing solution used for the photosensitive film formed by using the positive photosensitive composition of the present invention, a developing solution comprising an inorganic alkali (e.g., salts of Na or K) or an organic alkali (e.g., TMAH (Tetra Methyl Ammonium Hydroxide) or choline) is preferable.

The development is carried out at usually about 15 to 45° C. and preferably 22 to 32° C. by dipping development, spray development, brush development, ultrasonic development and so on.

### EXAMPLES

The present invention will be explained in more detail by way of examples, which are, however, shown as examples but should not be interpreted as limiting of the present invention.

### Example 1

The ingredients and proportions shown in Table 1 were used to prepare positive photosensitive compositions (5% of solid content) as test sensitizing solutions.

TABLE 1

| | | Proportion |
|---|---|---|
| | | (parts by |
| | Ingredients | weight) |
| Component(A) | Novolac resin | 100 |
| Component(B) | IR-photosensitive dye 1 | 1 |
| Component(C) | PVP/VA copolymer | 5 |
| Component(D) | Dissolution Inhibitor 1 | 5 |
| Solvent | PM | 800 |
| | IPA | 800 |
| | MEK | 600 |

Each component in Table 1 is as follows.

Novolac resin: PR-NMD-100 (manufactured by SUMITOMO BAKELITE Co., Ltd.)

IR-photosensitive dye 1: Cyanine series pigment.

PVA/VA copolymer: Copolymer of vinyl pyrrolidone and vinyl acetate (vinyl pyrrolidone/vinyl acetate: 50/50), molecular weight of 46,000 and glass transition point of 96° C.

Dissolution inhibitor 1: TrisP-PA (manufactured by Honshu Chemical Industry Co., Ltd., compound represented by the above formula (1)).

Resin E1: PVP/VA copolymer (copolymer of vinylpyrrolidone and vinyl acetate, vinylpyrrolidone/vinyl acetate: 50/50, molecular weight: 46,000, glass transition temperature: 96° C.).

PM: Propylene glycol monomethyl ether.

IPA: Isopropyl alcohol.

MEK: Methyl ethyl ketone.

The following experiments were made using the obtained test sensitizing solutions. The experiment was carried out under the condition that laboratory was maintained at a temperature of 25° C. and the humidity shown in Table 2. A plate-making roll of φ200 mm which used iron as base material of the roll and was plated with copper sulfate and mirror-polished was rotated at 25 r.p.m. with the both ends thereof being chucked by a fountain coating apparatus (apparatus equipped with a dehumidifier and a humidifier where the humidity can be controlled desirably) and thoroughly wiped and cleaned by a wiping cloth. It is to be noted that the fountain coating apparatus has the ability to avoid the phenomenon that solvents in the positive photosensitive composition are vaporized to change the ratio of these solvents during coating.

Thereafter, a pipe allowing the test sensitizing solution to be overflowed from the top thereof was positioned at one end of the plate-making roll so as to form a gap of about 500 μm from the roll. The pipe was moved from one end to the other end of the roll with making the test sensitizing solution overflow in an amount necessary for coating, to apply the test sensitizing solution uniformly to the roll by a spiral scan method, and the rotation was continued at 25 r.p.m. for 5 minutes after the application was finished and then stopped.

Five minutes were taken for waiting until oozing of a liquid was observed, with the result that the generation of the oozing of a liquid could not be observed with the naked eye. Then, the film thickness was measured, to find that there was no difference in thickness between the lower surface part and upper surface part of the roll. It was thus confirmed that the photosensitive film dried to a solid condition permitting no oozing of a liquid was set.

In succession, the test roll was rotated at 100 r.p.m. for 20 minutes and then stopped to measure the concentration of residual solvents in the photosensitive film, to find that the concentration was 2.9%.

Then, the test roll was fit to an exposure apparatus (manufactured by Think Laboratory) mounted with a high-power semiconductor laser head of CreoScitex Co., Ltd. and then irradiated with laser light having a wavelength falling in the infrared region to print a positive image. Next, the test roll was fit to a developing machine and was developed with rotating the roll and lifting the developing tank until no residue was observed, followed by washing with water. As the developing solution, 4.2% KOH (25° C.) was used. The resulting resist image was evaluated by a microscope. The results are shown in Table 2.

TABLE 2

| | | | | | Rate of | | | |
|---|---|---|---|---|---|---|---|---|
| | Humidity | | Sensitivity | Development | residual | | Resolution | Latitude of |
| | (%) | Adhesion | (mJ/cm²) | (seconds) | film (%) | Image | of edges | development |
| Example 1-1 | 35 | ⊚ | 220 | 75 | 75 | ⊚ | ⊚ | ⊚ |
| Example 1-2 | 45 | ⊚ | 220 | 75 | 74 | ⊚ | ⊚ | ⊚ |
| Example 1-3 | 55 | ⊚ | 220 | 75 | 73 | ⊚ | ⊚ | ⊚ |

The methods of evaluation in Table 2 are as follows.

1) Resolution of Edges

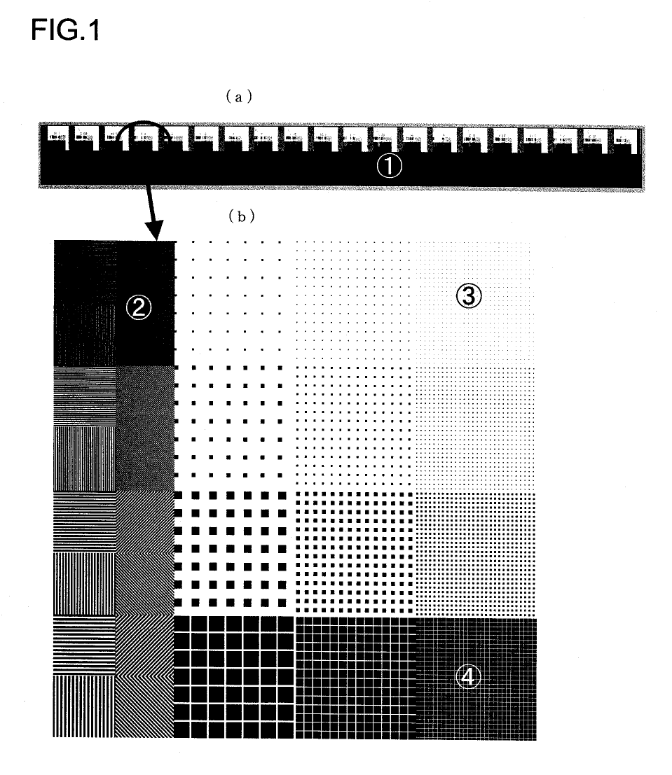

Using the resolution test pattern shown in FIG. 1, whether or not the edges of 7.9 μm line of a check and grating was sharp. In the table, “⊚” shows a good result and shows that the sample passed the resolution test and “x ” shows that no image was formed and plate-making could not be attained and the sample did not pass the resolution test.

2) Latitude of Development

The latitude of development was measured using a cellar (device capable of automatically measuring the opening ratio of dots) manufactured by Dai Nippon Printing Co., Ltd. A test was made in which the number of developing processes was increased (three times in the Example). In the case where the cell area falls in 60 to 75 μm² by exposure to light of 7.9 μm×7.9 μm, this cell area falls in the allowable range of printing density and shows that the latitude of development is good, which is expressed as “⊚” in the table. In the case where the cell area is out of the allowable range of printing, the latitude of development is expressed as “x” in the table.

3) Adhesion

The tesa test: in a cross-cut adhesion test using a DIN EN ISO 2409 tesa tape, the case where 100 squares all remain is defined as “⊚”, the case where squares less than 20% are peeled is defined as “∘” and the case where 20% or more of squares are peeled is defined as “x”.

4) Sensitivity

Exposure amount was varied to find one at which an image pattern was reproduced most exactly to decide the sensitivity. As the exposure apparatus, a thermal imaging head manufactured by Creo Co., Ltd. was used.

5) Development

The development time taken until no residue was found was measured.

6) The Rate of Residual Film

Film thicknesses before and after development were measured using FILMETRICS Thin Film Analyzer F20 (manufactured by Filmetrics Co.) which calculate thickness of coating film to calculate the rate of residual film.

7) Image

The reproducibility of an original image was evaluated. ⊚: Very good, x: Very inferior, -: An image disappeared by development.

The test pattern of the sensitizing solution and measuring positions are shown in FIG. 1. Check items and measuring method for the measuring positions in FIG. 1 are shown in Table 3.

TABLE 3

| | | | Measurement |
|---|---|---|---|
| Measuring | | | of area |
| Positions | Check items | Photography | (Cellzoh) |
| \textcircled{1} | Presence or absence | — | — |
| | of developing residue | | |
| \textcircled{2} | 1 Pixel checker | ◯ | — |
| \textcircled{3} | 1 Pixel highlight | ◯ | ◯ |
| \textcircled{4} | 7 μm grating | ◯ | ◯ |

As shown in Table 2, the positive photosensitive composition of Example 1 made it possible to carry out good development to obtain a sharp pattern freed of residues in about 70 seconds in the condition of a room temperature of 25° C. and a humidity of 35 to 55%. Also, a good latitude of development was obtained.

The experiment was also made in the case of using a copper surface or an aluminum surface in place of the copper sulfate plating surface. In all of these cases, the same satisfactory results as in Example 1 were obtained. In the case of the aluminum surface, a especially wide latitude of development was obtained.

### Examples 2 to 6

The same experiments as in Example 1 were made except that the component (B) in the compositions were altered as shown in Table 4. The measurement was made under a humidity of 45%. The results are shown in Table 4.

TABLE 4

| | | | | | Rate of | | | |
|---|---|---|---|---|---|---|---|---|
| | Component | | Sensitivity | Development | Residual | | Resolution | Latitude of |
| | (B) | Adhesion | (mJ/cm²) | (Seconds) | film (%) | Image | of edges | development |
| Example 2 | Pigment 2 | ⊚ | 220 | 75 | 76 | ⊚ | ⊚ | ⊚ |
| Example 3 | Pigment 3 | ⊚ | 220 | 75 | 73 | ⊚ | ⊚ | ⊚ |
| Example 4 | Pigment 4 | ⊚ | 220 | 75 | 72 | ⊚ | ⊚ | ⊚ |
| Example 5 | Pigment 5 | ⊚ | 220 | 75 | 73 | ⊚ | ⊚ | ⊚ |
| Example 6 | Pigment 6 | ⊚ | 220 | 75 | 75 | ⊚ | ⊚ | ⊚ |

In Table 4, the proportion of the component (B) to be compounded is the same as that in Example 1, and the dyes 2˜6 are the compounds represented in the formulae of (2), (4)˜(7), respectively.

### Examples 7˜9

Experiments were made in the same manner as in Example 1 except that the component (A) was altered as shown in Table 5. The measurement was performed in the condition of 45% humidity. The results are also shown in Table 5.

TABLE 5

| | | | | | Rate of | | | |
|---|---|---|---|---|---|---|---|---|
| | Component | | Sensitivity | Development | Residual | | Resolution | Latitude of |
| | (A) | Adhesion | (mJ/cm²) | (seconds) | film (%) | Image | of edged | development |
| Example 7 | Resin 1 | ⊚ | 220 | 75 | 72 | ⊚ | ⊚ | ⊚ |
| Example 8 | Resin 2 | ⊚ | 220 | 75 | 74 | ⊚ | ⊚ | ⊚ |
| Example 9 | Resin 3 | ⊚ | 220 | 75 | 75 | ⊚ | ⊚ | ⊚ |

In Table 5, the proportion of the component (A) to be compounded is the same as that used in Example 1, and the resins 1˜3 are as follows.

Resin 1: Alkyl phenol resin (Hitanol 2181, a trade name manufactured by Hitachi Chemical Co., Ltd.)

Resin 2: p-vinyl phenol butyl acrylate copolymer (Marukarinker CBA, a trade name manufactured by Maruzen Oil Co., Ltd.)

Resin 3: Polyvinyl phenol resin (Marukarinker M, a trade name manufactured by Maruzen Oil Co., Ltd.)

### Examples 10˜20

Experiments were made in the same manner as in Example 1 except that each of copolymers shown in Table 6 was used instead of the PVA/VA copolymer as the component (C). The measurement was performed in the condition of 45% humidity. The results are shown also in Table 6.

TABLE 6

| | | | | | Rate of | | | |
|---|---|---|---|---|---|---|---|---|
| Example | Component | | Sensitivity | Development | residual | | Resolution | Latitude of |
| No. | (C) | Adhesion | (mJ/cm²) | (seconds) | film (%) | Image | of edges | development |
| 10 | Polymer 1 | ⊚ | 180 | 75 | 75 | ⊚ | ⊚ | ⊚ |
| 11 | Polymer 2 | ⊚ | 180 | 70 | 69 | ⊚ | ⊚ | ⊚ |
| 12 | Polymer 3 | ⊚ | 180 | 75 | 74 | ⊚ | ⊚ | ⊚ |
| 13 | Polymer 4 | ⊚ | 180 | 75 | 69 | ⊚ | ⊚ | ⊚ |
| 14 | Polymer 5 | ⊚ | 180 | 72 | 73 | ⊚ | ⊚ | ⊚ |
| 15 | Polymer 6 | ⊚ | 180 | 75 | 75 | ⊚ | ⊚ | ⊚ |
| 16 | Polymer 7 | ⊚ | 180 | 72 | 72 | ⊚ | ⊚ | ⊚ |
| 17 | Polymer 8 | ⊚ | 180 | 73 | 73 | ⊚ | ⊚ | ⊚ |
| 18 | Polymer 9 | ⊚ | 180 | 70 | 70 | ⊚ | ⊚ | ⊚ |
| 19 | Polymer 10 | ⊚ | 180 | 69 | 69 | ⊚ | ⊚ | ⊚ |
| 20 | Polymer 11 | ⊚ | 180 | 68 | 68 | ⊚ | ⊚ | ⊚ |

In Table 6, the proportion of the component (C) to be compounded is the same as that used in Example 1, and the polymers 1˜11 are as follows.

Polymer 1: GAFQUAT 734 (vinyl pyrrolidon/dimethylaminoethyl methacrylate copolymer manufactured by International Specialty Products)

Polymer 2: GAFFIX VC-713 (vinyl pyrrolidon/vinyl caprolactam/dimethylaminoethyl methacrylate copolymer manufactured by International Specialty Products)

Polymer 3: Sacnol SN-09T (polyvinyl acetate manufactured by DENKI KAGAKU KOGYO KABUSHIKI KAISHA)

Polymer 4: DENKA Butyral #3000 (polyvinyl butyral manufactured by DENKI KAGAKU KOGYO KABUSHIKI KAISHA)

Polymer 5: Vinylec-K type (polyvinyl formal manufactured by CHISSO CORPORATION)

Polymer 6: Oxylac SH-101 Derivative (styrene/maleic acid copolymer added with glycidyl methacrylate, acid value of 80)

Polymer 7: Tamanoru 803L (terpene phenol resin manufactured by Arakawa Chemical Industries, LTD)

Polymer 8: Tamanoru 520S (alkyl phenol resin manufactured by Arakawa Chemical Industries, LTD)

Polymer 9: Banceline SM-960 (melamine/formaldehyde resin manufactured by HARIMA CHMICALS, INC.)

Polymer 10: Hilac 111 (cyclohexane resin manufactured by Hitachi Chemical Co., Ltd.)

Polymer 11: Hilac 110H (acetophenone resin manufactured by Hitachi Chemical Co., Ltd.)

### Examples 21˜42

Experiments were made in the same manner as in Example 1 except that the resins and copolymers shown in Table 7 or Table 8 were used as the components (A) and (C), respectively. The measurement was performed in the condition of 45% humidity. The results are shown also in Tables 7 and 8. In Tables 7 and 8, each of the proportions of the components (A) and (C) to be compounded is the same as that in Example 1, the resins 2 and 3 are the same ones shown in Table 5, and the polymers 1 to 11 are the same ones shown in Table 6.

TABLE 7

| | | | | | | Rate of | | | |
|---|---|---|---|---|---|---|---|---|---|
| Example | Component | Component | | Sensitivity | Development | residual | | Resolution | Latitude of |
| No. | (A) | (C) | Adhesion | (mJ/cm²) | (seconds) | film (%) | Image | of edges | development |
| 21 | Resin 2 | Polymer 1 | ⊚ | 180 | 75 | 75 | ⊚ | ⊚ | ⊚ |
| 22 | Resin 2 | Polymer 2 | ⊚ | 180 | 70 | 69 | ⊚ | ⊚ | ⊚ |
| 23 | Resin 2 | Polymer 3 | ⊚ | 180 | 75 | 74 | ⊚ | ⊚ | ⊚ |
| 24 | Resin 2 | Polymer 4 | ⊚ | 180 | 75 | 69 | ⊚ | ⊚ | ⊚ |
| 25 | Resin 2 | Polymer 5 | ⊚ | 180 | 72 | 73 | ⊚ | ⊚ | ⊚ |
| 26 | Resin 2 | Polymer 6 | ⊚ | 180 | 75 | 75 | ⊚ | ⊚ | ⊚ |
| 27 | Resin 2 | Polymer 7 | ⊚ | 180 | 72 | 72 | ⊚ | ⊚ | ⊚ |
| 28 | Resin 2 | Polymer 8 | ⊚ | 180 | 73 | 73 | ⊚ | ⊚ | ⊚ |
| 29 | Resin 2 | Polymer 9 | ⊚ | 180 | 70 | 70 | ⊚ | ⊚ | ⊚ |
| 30 | Resin 2 | Polymer 10 | ⊚ | 180 | 69 | 69 | ⊚ | ⊚ | ⊚ |
| 31 | Resin 2 | Polymer 11 | ⊚ | 180 | 68 | 68 | ⊚ | ⊚ | ⊚ |

TABLE 8

| | | | | | | Rate of | | | |
|---|---|---|---|---|---|---|---|---|---|
| Example | Component | Component | | Sensitivity | Development | residual | | Resolution | Latitude of |
| No. | (A) | (C) | Adhesion | (mJ/cm²) | (seconds) | film (%) | Image | of edges | development |
| 32 | Resin 3 | Polymer 1 | ⊚ | 180 | 75 | 75 | ⊚ | ⊚ | ⊚ |
| 33 | Resin 3 | Polymer 2 | ⊚ | 180 | 70 | 69 | ⊚ | ⊚ | ⊚ |
| 34 | Resin 3 | Polymer 3 | ⊚ | 180 | 75 | 74 | ⊚ | ⊚ | ⊚ |
| 35 | Resin 3 | Polymer 4 | ⊚ | 180 | 75 | 69 | ⊚ | ⊚ | ⊚ |
| 36 | Resin 3 | Polymer 5 | ⊚ | 180 | 72 | 73 | ⊚ | ⊚ | ⊚ |
| 37 | Resin 3 | Polymer 6 | ⊚ | 180 | 75 | 75 | ⊚ | ⊚ | ⊚ |
| 38 | Resin 3 | Polymer 7 | ⊚ | 180 | 72 | 72 | ⊚ | ⊚ | ⊚ |
| 39 | Resin 3 | Polymer 8 | ⊚ | 180 | 73 | 73 | ⊚ | ⊚ | ⊚ |
| 40 | Resin 3 | Polymer 9 | ⊚ | 180 | 70 | 70 | ⊚ | ⊚ | ⊚ |
| 41 | Resin 3 | Polymer 10 | ⊚ | 180 | 69 | 69 | ⊚ | ⊚ | ⊚ |
| 42 | Resin 3 | Polymer 11 | ⊚ | 180 | 68 | 68 | ⊚ | ⊚ | ⊚ |

### Comparative Examples 1˜3

Experiments were made in the same manner as in Example 1 except that the proportion of each of the positive photosensitive compositions resins was changed as shown in Table 9. The measurement was performed in the condition of 45% humidity. The results are shown also in Table 10.

TABLE 9

| | Comparative | Comparative | Comparative |
|---|---|---|---|
| | Example 1 | Example 2 | Example 3 |
| Component(A) Novolac | 100 | 100 | 100 |
| Resin | | | |
| Component(B) | 1 | 1 | 1 |
| IR-photosensitive dye 1 | | | |
| Component(B) Titanium | — | 2 | — |
| organic compound | | | |
| Component(B) Imidazole | — | — | 2 |
| silane | | | |
| Solvent | | | |
| PM | 800 | 800 | 800 |
| IPA | 800 | 800 | 800 |
| MEK | 600 | 600 | 600 |

In Table 9, the novolac resin, the IR-photosensitive dye 1 and the solvent are the same as those shown in Table 1, and the other components are as follows.
Titanium organic compound: Orgachicks TA-10 (Titanium alcoxide) manufactured by Matsumoto Chemical Industry Co., Ltd.

Imidazole silane: The silane coupling agent having the following formula (17). In the formula (17), each of R¹˜R⁴ is an alkyl group, n is an integer from 1 to 3.

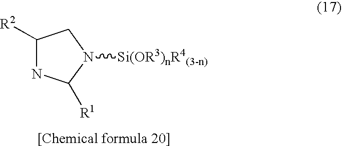

TABLE 10

| | | | | Rate of | | | |
|---|---|---|---|---|---|---|---|
| | | Sensitivity | Development | residual | | Resolution | Latitude of |
| | Adhesion | (mJ/cm²) | (seconds) | film (%) | Image | of edges | development |
| Comparative | ∘ | 180-250 | 60 | 0 | — | x | x |
| Example 1 | | | | | | | |
| Comparative | ∘ | 180-250 | 60 | 0 | — | x | x |
| Example 2 | | | | | | | |
| Comparative | ∘ | 180-250 | 60 | 0 | — | x | x |
| Example 3 | | | | | | | |

As shown in Table 10, in each of Comparative Examples, the images disappeared after development and no latitude of development was obtained at all.

### Comparative Examples 4˜15

Experiments were made in the same manner as in Examples 1, 10 to 20 except that the dissolution inhibitor 1 was not added. The results are shown in Table 11.

TABLE 11

| | | | | Rate of | | | |
|---|---|---|---|---|---|---|---|
| | | Sensitivity | Development | residual | | Resolution | Latitude of |
| | Adhesion | (mJ/cm²) | (seconds) | film (%) | Image | of edges | development |
| Comparative | ∘ | 180-250 | 60 | 0 | — | x | x |
| Example 4 | | | | | | | |
| Comparative | ∘ | 180-250 | 60 | 12 | x | x | x |
| Example 5 | | | | | | | |
| Comparative | ∘ | 180-250 | 60 | 0 | — | x | x |
| Example 6 | | | | | | | |
| Comparative | ∘ | 180-250 | 60 | 0 | — | x | x |
| Example 7 | | | | | | | |
| Comparative | ∘ | 180-250 | 60 | 0 | — | x | x |
| Example 8 | | | | | | | |
| Comparative | ∘ | 180-250 | 60 | 0 | — | x | x |
| Example 9 | | | | | | | |
| Comparative | ∘ | 180-250 | 60 | 0 | — | x | x |
| Example 10 | | | | | | | |
| Comparative | ∘ | 180-250 | 60 | 10 | x | x | x |
| Example 11 | | | | | | | |
| Comparative | ∘ | 180-250 | 60 | 5 | x | x | x |
| Example 12 | | | | | | | |
| Comparative | ∘ | 180-250 | 60 | 0 | — | x | x |
| Example 13 | | | | | | | |
| Comparative | ∘ | 180-250 | 60 | 0 | — | x | x |
| Example 14 | | | | | | | |
| Comparative | ∘ | 180-250 | 60 | 0 | — | x | x |
| Example 15 | | | | | | | |

Capability of Exploitation in Industry:

The positive photosensitive composition of the present invention is preferably used to form a positive photosensitive film on the copper sulfate surface of a plate-making roll for gravure printing. However, no particular limitation to the material on which the composition of the present invention is applied. Even if the composition is applied to plates of metals such as aluminum, zinc and steel, metal plates on which aluminum, zinc, copper, iron, chromium, nickel, or the like is plated or deposited, paper coated with a resin, paper coated with a metal foil such as an aluminum foil, plastic films, hydrophilically treated plastic films, glass plates, and so on, it has high adhesion at low temperatures, ensuring that high sensitivity is obtained.

The positive photosensitive composition of the present invention is, therefore, preferably used for photosensitive planographic printing plates, proofs for simplified proofing printing, wiring boards, gravure copper etching resists, color-filter resists used to produce flat displays, photoresists for producing LSI and the like.

1. A positive photosensitive composition comprising:
(A) an alkali soluble organic high molecular substance having a phenolic hydroxyl group,
(B) a photo-thermal conversion material that absorbs infrared rays from an image exposure light source and converts it to heat,
(C) at least one resin selected from the group consisting of: (1) vinylpyrrolidone/vinyl acetate copolymer, (2) vinylpyrrolidone/dimethyl-aninoethyl methacrylate copolymer, (3) vinylpyrrolidone/vinyl caprolactam/dimethylaminoethyl methacrylate copolymer, (4) polyvinyl acetate, (5) polyvinyl butyral, (6) polyvinyl formal, (7) styrene/maleic acid copolymer, (8) terpene phenol resin, (9) alkylphenol resin, (10) melamine/formaldehyde resin, and (11) ketone resin, and
(D) a dissolution inhibitor.

2. The positive photosensitive composition according to claim 1, wherein the dissolution inhibitor (D) is a compound represented by the following chemical formula (1).

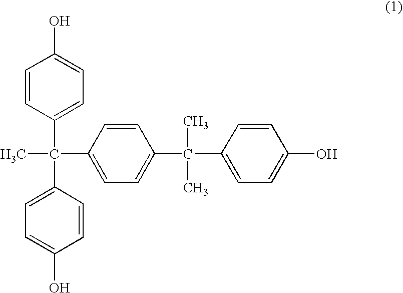

3. The positive photosensitive composition according to claim 1, wherein the photo-thermal conversion material (B) is a compound represented by the following formula (2). 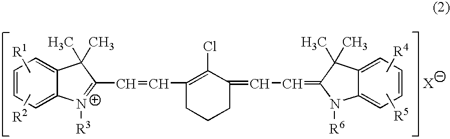
wherein each of “R¹” to “R⁶” independently represents a hydrogen atom, an alkyl group having 1 to 3 carbon atoms, or an alkoxyl group having 1 to 3 carbon atoms, and “X” represents a halogen atom, ClO₄, BF_{4,} p-CH₃C₆H₄SO₃, or PF₆.

4. The positive photosensitive composition according to claim 1, wherein the photo-thermal conversion material (B) is a compound represented by the following formula (3). 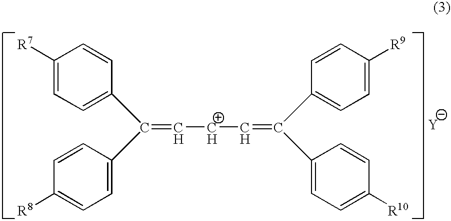
wherein each of “R⁷”˜“R¹⁰” independently represents a hydrogen atom, a methoxyl group, N(CH₃)₂, or N(C₂H₅)₂, and “Y” represents C₄H₉—B(C₆H₅)₃, p-CH₃C₆H₄SO₃, or CF₃SO₃.

5. A photofabrication method comprising:
exposing the positive photosensitive composition as defined in claim 1 to a laser beam having a wavelength of from 700 to 1,100 nm. to form a positive image.

6. The photo fabrication method according to claim 5, which is applied to production of a printing plate, an electronic component and a precision equipment component.

7. A plate-making method comprising:
exposing the positive photosensitive composition as defined in claim 1 to a laser beam having a wavelength of from 700 to 1,100 nm. to form a positive image.

8. The positive photosensitive composition according to claim 2, wherein the photo-thermal conversion material (B) is a compound represented by the following formula (2). 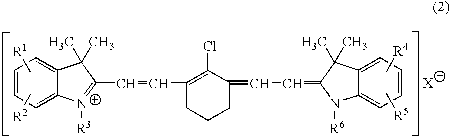
wherein each of “R¹” to “R⁶” independently represents a hydrogen atom, an alkyl group having 1 to 3 carbon atoms, or an alkoxyl group having 1 to 3 carbon atoms, and “X” represents a halogen atom, ClO₄, BF_{4,} p-CH₃C₆H₄SO₃, or PF₆.

9. The positive photosensitive composition according to claim 2, wherein the photo-thermal conversion material (B) is a compound represented by the following formula (3). 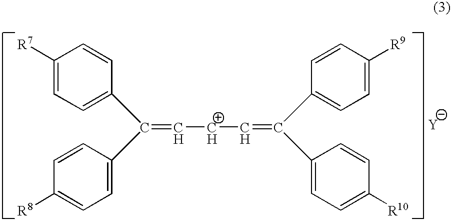
wherein each of “R⁷”˜“R¹⁰” independently represents a hydrogen atom, a methoxyl group, N(CH₃)₂, or N(C₂H₅)₂, and “Y” represents C₄H₉—B(C₆H₅)₃, p-CH₃C₆H₄SO₃, or CF₃SO₃.

10. A photofabrication method comprising:
exposing the positive photosensitive composition as defined in claim 2 to a laser beam having a wavelength of from 700 to 1,100 nm. to form a positive image.

11. The photofabrication method according to claim 10, which is applied to production of a printing plate, an electronic component and a precision equipment component.

12. A plate-making method comprising:
exposing the positive photosensitive composition as defined in claim 2 to a laser beam having a wavelength of from 700 to 1,100 nm. to form a positive image.
